(19) United States
(12) Patent Application Publication
(10) Pub. No.: US 2012/0120005 A1
(43) Pub. Date: May 17, 2012

(54) TOUCH SCREEN PANEL DISPLAY

(75) Inventor: Tae Sung KIM, Seoul (KR)

(73) Assignee: SAMSUNG ELECTRONICS CO. LTD., Suwon-si (KR)

(21) Appl. No.: 13/176,062

(22) Filed: Jul. 5, 2011

(30) Foreign Application Priority Data
Nov. 12, 2010 (KR) 10-2010-0112376

(51) Int. Cl. G06F 3/041

(52) U.S. Cl. 345/173

(57) ABSTRACT

A touch screen panel display for displaying a three-dimensional image including a display, a touch screen panel sensor film stacked on top of the display, and a window stacked on top of the touch screen panel sensor film is provided. The touch screen panel display includes a viewing angle difference barrier film stacked between an upper surface of the touch screen panel sensor film and a lower surface of the window and for transmitting light of a pixel corresponding to a left eye and light of a pixel corresponding to a right eye to a left eye and a right eye, respectively. The touch screen panel display displays a three-dimensional image using a two-dimensional liquid crystal display.

### PRIORITY

This application claims the benefit under 35 U.S.C. §119(a) of a Korean patent application filed on Nov. 12, 2010 in the Korean Intellectual Property Office and assigned Serial No. 10-2010-0112376, the entire disclosure of which is hereby incorporated by reference.

### BACKGROUND OF THE INVENTION

1. Field of the Invention

The present invention relates to a touch screen panel display. More particularly, the present invention relates to a touch screen panel display for displaying a three-dimensional image.

2. Description of the Related Art

With increased use of a three-dimensional television, a three-dimensional display product is increasingly desired for other types of products. For example, there has been an increase demand for a three-dimensional display for a mobile terminal With three-dimensional broadcasting being broadcasted through a Korean terrestrial broadcasting channel No. 66, three-dimensional broadcasting has been provided to a user based on three-dimensional contents generated by a terrestrial broadcasting station.

However, since a display device of a conventional mobile terminal uses a Two-Dimensional (2D) Liquid Crystal Display (LCD) that can display only a 2D image, a Three-Dimensional (3D) image cannot be displayed. Therefore, a 3D LCD that can display a 3D image on a display device of a mobile terminal has been introduced. However, the 3D LCD is manufactured with a method of adding another matrix to a rear side of the 2D LCD and thus production costs of the 3D LCD has increased.

Therefore, a need exists for a touch screen panel display device of a mobile terminal with decreased manufacturing costs for displaying a 3D image.

### SUMMARY OF THE INVENTION

An aspect of the present invention is to address at least the above-mentioned problems and/or disadvantages and to provide at least the advantages described below. Accordingly, an aspect of the present invention is to provide a Two-Dimensional (2D) Liquid Crystal Display (LCD) touch screen panel for displaying a Three-Dimensional (3D) image.

In accordance with an aspect of the present invention, a touch screen panel display including a display, a touch screen panel sensor film stacked on top of the display, and a window stacked on top of the touch screen panel sensor film is provided. The touch screen panel display includes a viewing angle difference barrier film stacked between an upper surface of the touch screen panel sensor film and a lower surface of the window and for transmitting light of a pixel corresponding to a left eye and light of a pixel corresponding to a right eye to a left eye and a right eye, respectively.

In accordance with another aspect of the present invention, a touch screen panel display including a display, a touch screen panel sensor film stacked on top of the display, and a window stacked on top of the touch screen panel sensor film is provided. The touch screen panel display includes a viewing angle difference barrier film stacked between an upper surface of the display and a lower surface of the touch screen panel sensor film and for transmitting light of a pixel corresponding to a left eye and light of a pixel corresponding to a right eye to a left eye and a right eye, respectively

In accordance with still another aspect of the present invention, a touch screen panel display is provided. The touch screen panel display includes a display, a touch screen panel sensor film stacked on top of the display, a window stacked on top of the touch screen panel sensor film, the touch screen panel display comprising, and a viewing angle difference barrier film stacked at least one of between an upper surface of the touch screen panel sensor film and a lower surface of the window and between at an upper surface of the display and a lower surface of the touch screen panel sensor.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a mobile terminal including a touch screen panel display according to an exemplary embodiment of the present invention;

FIG. 2 is a cross-sectional view illustrating the touch screen panel display taken along a dotted line A-A′ of FIG. 1;

FIG. 3 illustrates a viewing angle difference barrier film of the touch screen panel display of FIG. 2;

FIG. 4 is a diagram illustrating a process of displaying a three-dimensional image in a touch screen panel display according to an exemplary embodiment of the present invention; and

FIG. 5 is a cross-sectional view illustrating a touch screen panel display according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

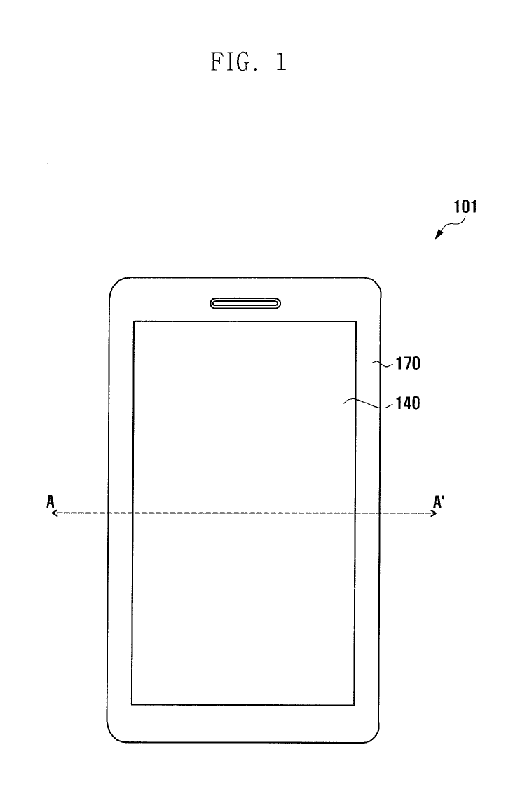

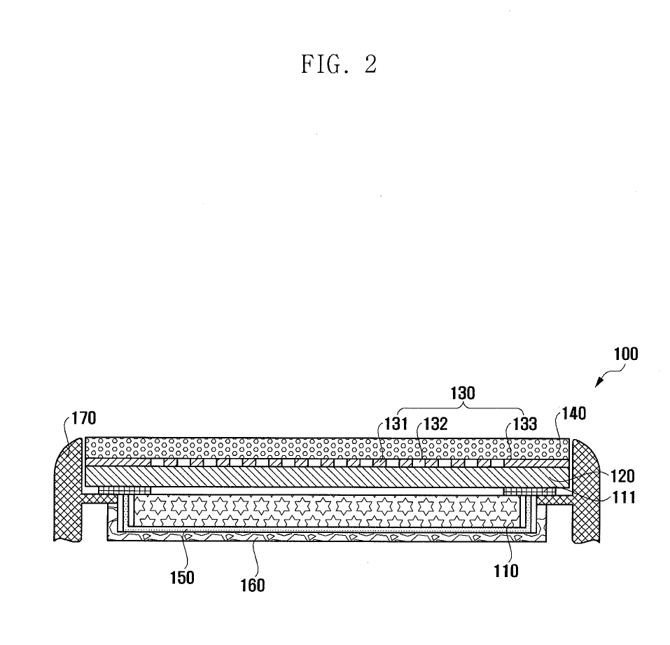

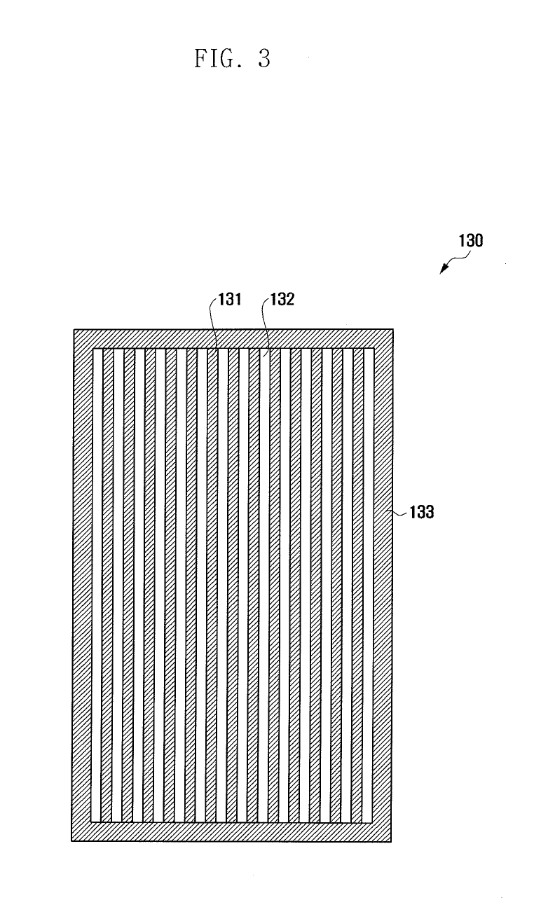

FIG. 1 illustrates a mobile terminal having a touch screen panel display according to an exemplary embodiment of the present invention. FIG. 2 is a cross-sectional view illustrating the touch screen panel display taken along a dotted line A-A′ of FIG. 1, FIG. 3 illustrates a viewing angle difference barrier film of the touch screen panel display of FIG. 2.

For reference, the dotted line A-A′ of FIG. 1 is represented in a horizontal direction of a mobile terminal 101.

Referring to FIGS. 1 to 3, a touch screen panel display according to an exemplary embodiment of the present invention is described. As illustrated in FIG. 2, a touch screen panel display 100 includes a display 110, a touch screen panel sensor film 120, a window 140, and a viewing angle difference barrier film 130.

The display 110 is an element for displaying an image. In an exemplary implementation, the display 110 is formed with a Two-Dimensional (2D) Liquid Crystal Display (LCD) or a 2D Active Matrix Organic Light Emitting Diode (AMOLED). A mold 150 and a bracket 160 for protecting and supporting the display 110 are disposed at a lower part of the display 110.

The touch screen panel sensor film 120 is an element for recognizing a user touch and is stacked on top of the display 110. The touch screen panel sensor film 120 may be formed with a film of a polyethylene terephthalate (PET) material in which an indium tin oxide (ITO) pattern is formed. A double-sided tape 111 for fixing the touch screen panel sensor film 120 and the display 110 is attached to the edge of a lower surface of the touch screen panel sensor film 120.

The window 140, which protects the touch screen panel sensor film 120, is an element for inputting a user touch, and is stacked on top of the touch screen panel sensor film 120. The window 140 may be formed with PET or glass. On the outside of the window 140 and the touch screen panel sensor film 120, an upper frame 170 for protecting the touch screen panel display 100 from an external impact is formed.

The viewing angle difference barrier film 130 is an element for transmitting light of a pixel corresponding to a left eye and light of a pixel corresponding to a right eye to a left eye and a right eye, respectively and is stacked between an upper surface of the touch screen panel sensor film 120 and a lower surface of the window 140. The viewing angle difference barrier film 130 is formed with a light shielding portion 131 and a light transmitting portion 132 that are alternately disposed, and a black mark forming portion 133. In an exemplary implementation, the black mark forming portion 133 is formed in the viewing angle difference barrier film 130. However, the black mark forming portion may be formed with a printing method at the edge of a lower surface of the window 140. The light transmitting portion 132 may be formed with a film of a transparent material and not with an empty space. When the light transmitting portion 132 is formed with an empty space, definition of a screen may decrease due to reflection of a refractive index difference between the window 140 and the light transmitting portion 132. However when the light transmitting portion 132 is formed with a film of a transparent material, a refractive index difference decreases and thus definition of a screen can be prevented from decreasing.

Because the light shielding portion 131 of FIGS. 2 and 3 is extended in a vertical direction of the mobile terminal 101, a user can view a three-dimensional image with the mobile terminal 101 when the display of the mobile terminal 101 is positioned in a vertical direction, as illustrated in FIG. 1. Alternatively, the light shielding portion 131 may be extended in a horizontal direction of the mobile terminal 101. In this case, the user can view a three-dimensional image with the mobile terminal 101 positioned in a horizontal direction.

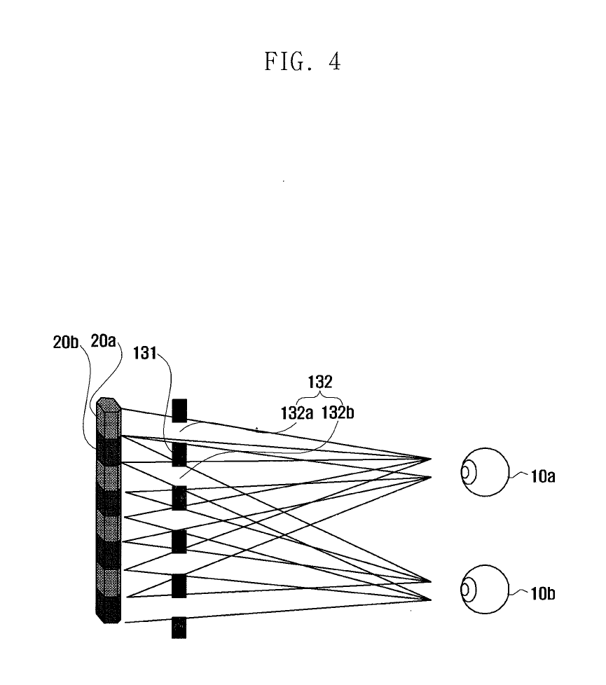

FIG. 4 is a diagram illustrating a process of displaying a 3D image in a touch screen panel display according to an exemplary embodiment of the present invention.

Referring to FIG. 4, a pixel 20a for a right eye 10a and a pixel 20b for a left eye 10b are alternately formed in the display 110, and the light shielding portion 131 is formed at the front of the pixel 20a for the right eye 10a and the pixel 20b for the left eye 10b. Light of the pixel 20a for a right eye and light of the pixel 20b for a left eye passes through light transmitting portions 132a and 132b formed at the side of the light shielding portion 131 and advances toward the right eye 10a and the left eye 10b. Accordingly, the user can view an image having a 3D effect.

According to an exemplary embodiment of the present embodiment, as the viewing angel difference barrier film 130 is formed in a touch screen panel, a touch screen panel display can display a 3D image while using a conventional 2D LCD with inexpensive manufacturing costs.

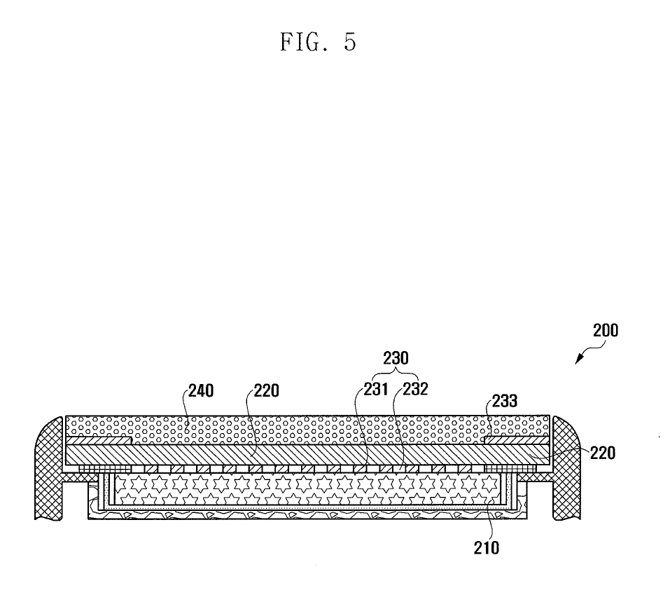

FIG. 5 is a cross-sectional view illustrating a touch screen panel display according to an exemplary embodiment of the present invention.

Referring to FIG. 5, unlike the touch screen panel described above with reference to FIG. 2, in a touch screen panel display 200, a viewing angle difference barrier film 230 including a light shielding portion 231 and a light transmitting portion 232 is stacked between an upper surface of a display 210 and a lower surface of a touch screen panel sensor film 220. Accordingly, a black mark forming portion 233 is not formed in the viewing angle difference barrier film 230, but is formed at the edge of a lower surface of a window 240 with a printing method. The touch screen panel display 200 according to an exemplary embodiment has a configuration similar to that of the touch screen panel display 100 as described with reference to FIG. 2, except for the above configuration.

The light transmitting portion 232 according to an exemplary embodiment of the present invention may be formed with a film of a transparent material and not with an empty space. In a conventional touch screen panel display, an air gap is formed between the display 210 and the touch screen panel sensor film 220. Thus definition of a screen decreases because of reflection due to a refractive index difference. However, since the light transmitting portion 232 is formed with a film of a transparent material, reflection due to a refractive index difference is prevented and thus definition of a screen can increase.

As described above, according to exemplary embodiments of the present invention, because a viewing angle difference barrier film is stacked between an upper surface of a touch screen panel sensor film and a lower surface of a window, or between an upper surface of a display and a lower surface of a touch screen panel sensor film, a touch screen panel display displaying a 3D image can be manufactured inexpensively using a 2D LCD.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A touch screen panel display comprising a display, a touch screen panel sensor film stacked on top of the display, and a window stacked on top of the touch screen panel sensor film, the touch screen panel display comprising:
a viewing angle difference barrier film stacked between an upper surface of the touch screen panel sensor film and a lower surface of the window and for transmitting light of a pixel corresponding to a left eye and light of a pixel corresponding to a right eye to a left eye and a right eye, respectively.

2. The touch screen panel display of claim 1, wherein the viewing angle difference barrier film comprises a light shielding portion and a light transmitting portion that are alternately disposed.

3. The touch screen panel display of claim 2, wherein the light transmitting portion is formed with a film of a transparent material.

4. The touch screen panel display of claim 2, wherein the light shielding portion is extended in at least one of a vertical direction and a horizontal direction.

5. The touch screen panel display of claim 1, further comprising a black mark forming portion formed in the viewing angle difference barrier film.

6. A touch screen panel display comprising a display, a touch screen panel sensor film stacked on top of the display, and a window stacked on top of the touch screen panel sensor film, the touch screen panel display comprising:
a viewing angle difference barrier film stacked between an upper surface of the display and a lower surface of the touch screen panel sensor film and for transmitting light of a pixel corresponding to a left eye and light of a pixel corresponding to a right eye to a left eye and a right eye, respectively.

7. The touch screen panel display of claim 6, wherein the viewing angle difference barrier film comprises a light shielding portion and a light transmitting portion that are alternately disposed.

8. The touch screen panel display of claim 7, wherein the light transmitting portion is formed with a film of a transparent material.

9. The touch screen panel display of claim 7, wherein the light shielding portion is extended in at least one of a vertical direction and a horizontal direction.

10. The touch screen panel display of claim 6, further comprising a black mark forming portion formed at an edge of the lower surface of the widow with a printing method.

11. A touch screen panel display, comprising:
a display;
a touch screen panel sensor film stacked on top of the display;
a window stacked on top of the touch screen panel sensor film, the touch screen panel display comprising; and
a viewing angle difference barrier film that is at least one of stacked between an upper surface of the touch screen panel sensor film and a lower surface of the window and stacked between an upper surface of the display and a lower surface of the touch screen panel sensor film.

12. The touch screen panel display of claim 11, wherein the view angle difference barrier film transmits light of a pixel corresponding to a left eye and light of a pixel corresponding to a right eye to a left eye and a right eye, respectively.

13. The touch screen panel display of claim 12, wherein the viewing angle difference barrier film comprises a light shielding portion and a light transmitting portion that are alternately disposed.

14. The touch screen panel display of claim 13, wherein the light transmitting portion is formed with a film of a transparent material.

15. The touch screen panel display of claim 13, wherein the light shielding portion is extended in at least one of a vertical direction and a horizontal direction.

16. The touch screen panel display of claim 11, further comprising a black mark forming portion formed at an edge of the lower surface of the widow with a printing method.

17. The touch screen panel display of claim 11, wherein, when the viewing angle difference barrier film is stacked between an upper surface of the touch screen panel sensor film and a lower surface of the window, a mark forming portion is formed in the viewing angle difference barrier film.
